(19) United States
(12) Patent Application Publication
(10) Pub. No.: US 2026/0061813 A1
(43) Pub. Date: Mar. 5, 2026

(54) ELECTRIC VEHICLE MOTOR BRIDGE

(71) Applicant: Jinming Pei, Shiyan (CN)

(72) Inventor: Jinming Pei, Shiyan (CN)

(21) Appl. No.: 18/958,330

(22) Filed: Nov. 25, 2024

(30) Foreign Application Priority Data
Aug. 30, 2024 (CN) 2024112046033

(51) Int. Cl. B60K 1/02; B60K 1/04

(52) U.S. Cl. CPC B60K 1/02; B60K 1/04

(57) ABSTRACT

An electric vehicle motor bridge, comprising a gearbox, a first motor, a second motor, a third motor, and a fourth motor; the first motor and the second motor are symmetrically arranged at two ends of one side of the gearbox, and the third motor and the fourth motor are symmetrically arranged at two ends of the other side of the gearbox; therefore, the gearbox, the first motor, the second motor, the third motor, and the fourth motor form an H-shaped symmetrically distributed bridge structure as a whole. The motor bridge of the invention adopts a completely symmetrical layout structure, so that the mass of the whole vehicle is evenly distributed and the center of gravity of the whole vehicle is reduced as much as possible, thereby greatly improving the safety of vehicle driving. It can be arranged with 4 motor boxes, so that the total endurance mileage exceeds 1,000 kilometers.

### TECHNICAL FIELD

The invention relates to the technical field of automobiles, and in particular to an electric vehicle motor bridge.

### BACKGROUND ART

Electric vehicles are vehicles that use electricity as a power source, use motors to drive wheels, and comply with various requirements of road traffic and safety regulations. They are new energy vehicles. With the country vigorously promoting new energy vehicles, the number of electric vehicles on the market is increasing. At present, the unsatisfactory endurance mileage of electric vehicles has limited their full promotion.

### SUMMARY OF THE INVENTION

The technical problem to be solved by the invention is to overcome the defects of the above technology, provide an electric vehicle motor bridge, solve the problem of short endurance mileage of current electric vehicles, and improve vehicle safety.

In order to solve the above technical problems, the technical solution provided by the invention is: an electric vehicle motor bridge, comprising a gearbox, a first motor, a second motor, a third motor, and a fourth motor;
the first motor and the second motor are symmetrically arranged at two ends of one side of the gearbox, and the third motor and the fourth motor are symmetrically arranged at two ends of the other side of the gearbox; therefore, the gearbox, the first motor, the second motor, the third motor, and the fourth motor form an H-shaped symmetrically distributed bridge structure as a whole;
the first motor, the second motor, the third motor, and the fourth motor have the same structure;
a first battery box and a second battery box are provided between the first motor and the second motor, and a third battery box and a fourth battery box are provided between the third motor and the fourth motor; the first battery box, the second battery box, the third battery box, and the fourth battery box have the same structure; the first battery box and the second battery box, and the third battery box and the fourth battery box are symmetrically arranged along the transverse central axis of the gearbox; the first battery box and the fourth battery box are symmetrically arranged along the vertical center axis of the gearbox.

Further, the first motor, the second motor, the third motor, and the fourth motor adopt permanent magnet synchronous motors with the same structure.

Further, the first motor, the second motor, the third motor, and the fourth motor adopt a slender structure.

Further, the ratio of the length to the diameter of the first motor, the second motor, the third motor, and the fourth motor is not less than 3:1.

The advantages of the invention compared with the prior art are: the motor bridge of the invention adopts a completely symmetrical layout structure, so that the mass of the whole vehicle is evenly distributed and the center of gravity of the whole vehicle is reduced as much as possible, thereby greatly improving the safety of vehicle driving. The structure is reasonably designed and can be arranged with 4 motor boxes. A single motor box can accommodate a lithium battery pack with a capacity of up to 60 kWh and an endurance mileage of 400 kilometers, so that the total endurance mileage exceeds 1,000 kilometers, meeting the endurance mileage requirements of electric vehicles.

### BRIEF DESCRIPTION OF THE DRAWINGS

FIG. 1 is a schematic structural diagram of the electric vehicle motor bridge according to the invention.

As shown in the figures:
1 refers to the gearbox; 2 refers to the first motor; 3 refers to the second motor; 4 refers to the third motor; 5 refers to the fourth motor; 6 refers to the first battery box; 7 refers to the second battery box; 8 refers to the third battery box; 9 refers to the fourth battery box.

### SPECIFIC EMBODIMENT OF THE INVENTION

In order to make the objectives, technical solutions, and advantages of the embodiments of the invention clearer, the technical solutions in the embodiments of the invention will be described clearly and completely hereinafter with reference to the drawings in the embodiments of the invention. Obviously, the described embodiments are part of the embodiments of the invention, rather than all of the embodiments. The components of the embodiments of the invention generally described and illustrated in the drawings herein may be arranged and designed in various different configurations.

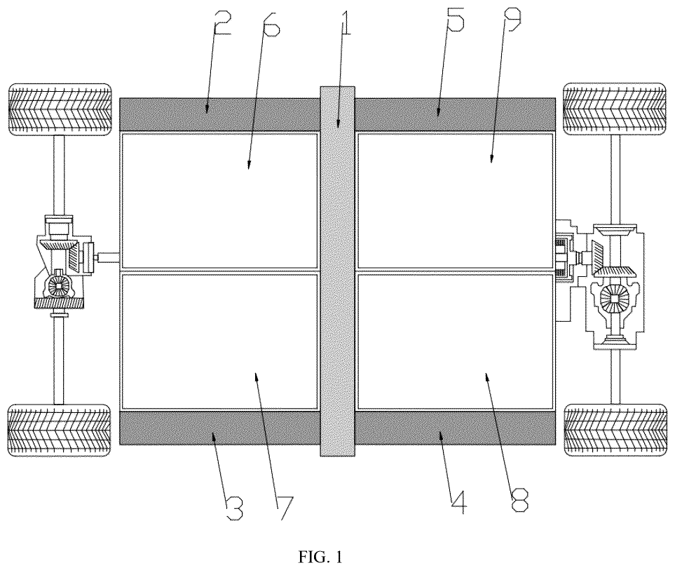

Embodiment 1: with reference to FIG. 1, an electric vehicle motor bridge, comprising a gearbox 1, a first motor 2, a second motor 3, a third motor 4, and a fourth motor 5;
the first motor 2 and the second motor 3 are symmetrically arranged at two ends of one side of the gearbox 1, and the third motor 4 and the fourth motor 5 are symmetrically arranged at two ends of the other side of the gearbox 1; therefore, the gearbox 1, the first motor 2, the second motor 3, the third motor 4, and the fourth motor 5 form an H-shaped symmetrically distributed bridge structure as a whole;
the first motor 2, the second motor 3, the third motor 4, and the fourth motor 5 have the same structure;
a first battery box 6 and a second battery box 7 are provided between the first motor and the second motor, and a third battery box and a fourth battery box are provided between the third motor and the fourth motor; the first battery box, the second battery box, the third battery box, and the fourth battery box have the same structure; the first battery box and the second battery box, and the third battery box and the fourth battery box are symmetrically arranged along the transverse central axis of the gearbox; the first battery box and the fourth battery box are symmetrically arranged along the vertical center axis of the gearbox.

In implementation, the motor bridge is arranged on the chassis of the vehicle, between the four wheels, and the output shaft of the gearbox 1 is connected to the driving shaft of the vehicle wheel, so that the wheel can be driven to rotate by the motor. Since the motor bridge adopts a completely symmetrical layout structure, the mass of the whole vehicle is evenly distributed, thereby greatly improving the safety of vehicle driving. By arranging 4 motor boxes, a single motor box can accommodate a lithium battery pack with a capacity of up to 60 kWh and an endurance mileage of 400 kilometers, so that the total endurance mileage exceeds 1,000 kilometers.

The first motor 2, the second motor 3, the third motor 4, and the fourth motor 5 adopt permanent magnet synchronous motors with the same structure, which use permanent magnets to provide excitation, making the motor structure simpler, reducing processing and assembly costs, and eliminating collector rings and brushes that are prone to problems, thereby improving the reliability of motor operation; and because no excitation current is required and there is no excitation loss, the efficiency and power density of the motor are improved, so it has the advantages of small size, simple structure and high power density.

The first motor 2, the second motor 3, the third motor 4, and the fourth motor 5 adopt a slender structure. The ratio of the length to the diameter of the first motor 2, the second motor 3, the third motor 4, and the fourth motor 5 is not less than 3:1, so that space utilization is more reasonable, the center of gravity of the vehicle is lowered as much as possible, and safety is further improved.

In the description of the invention, it needs to be understood that the orientation or positional relationship indicated by the terms “center”, “up”, “down”, “left”, “right”, “vertical”, “horizontal”, “inner”, “outer”, etc. are based on the orientation or positional relationship shown in the drawings, which are only for the convenience of describing the invention and simplifying the description, rather than indicating or implying that the device or element referred to must have a specific orientation, be constructed and operated in a specific orientation, and therefore cannot be understood as a limitation of the invention. In addition, the terms “first”, “second”, and “third” are only used for descriptive purposes, and cannot be understood as indicating or implying relative importance or implicitly indicating the number of indicated technical features.

In addition, the terms “horizontal”, “vertical”, “dangling”, etc. do not mean that the component is required to be absolutely horizontal or hanging, but may be slightly inclined. For example, “horizontal” only means that its direction is more horizontal than “vertical”, it does not mean that the structure must be completely horizontal, but can be slightly inclined.

In the description of the invention, “plurality”means at least two.

In the invention, unless otherwise clearly defined and limited, the terms “provided”, “installed”, “connected” and other terms should be interpreted broadly; for example, it can be a fixed connection, it can be a detachable connection, or integrated; it can be a mechanical connection or an electrical connection; it can be a direct connection, or an indirectly connection through an intermediate medium, and it can be an internal communication between two elements or the interaction relationship between two elements. For those of ordinary skill in the art, the specific meaning of the above terms in the invention can be understood according to specific circumstances.

The invention and the embodiments thereof are described hereinabove, and this description is not restrictive. What is shown in the drawings is only one of the embodiments of the invention, and the actual structure is not limited thereto. All in all, structural methods and embodiments similar to the technical solution without deviating from the purpose of the invention made by those of ordinary skill in the art without creative design shall all fall within the protection scope of the invention.

1. An electric vehicle motor bridge, comprising a gearbox, a first motor, a second motor, a third motor, and a fourth motor;
the first motor and the second motor are symmetrically arranged at two ends of one side of the gearbox, and the third motor and the fourth motor are symmetrically arranged at two ends of the other side of the gearbox; therefore, the gearbox, the first motor, the second motor, the third motor, and the fourth motor form an H-shaped symmetrically distributed bridge structure as a whole;
the first motor, the second motor, the third motor, and the fourth motor have the same structure;
a first battery box and a second battery box are provided between the first motor and the second motor, and a third battery box and a fourth battery box are provided between the third motor and the fourth motor; the first battery box, the second battery box, the third battery box, and the fourth battery box have the same structure; the first battery box and the second battery box, and the third battery box and the fourth battery box are symmetrically arranged along the transverse central axis of the gearbox; the first battery box and the fourth battery box are symmetrically arranged along the vertical center axis of the gearbox.

2. The electric vehicle motor bridge of claim 1, wherein the first motor, the second motor, the third motor, and the fourth motor adopt permanent magnet synchronous motors with the same structure.

3. The electric vehicle motor bridge of claim 2, wherein the first motor, the second motor, the third motor, and the fourth motor adopt a slender structure.

4. The electric vehicle motor bridge of claim 3, wherein the ratio of the length to the diameter of the first motor, the second motor, the third motor, and the fourth motor is not less than 3:1.
